(19) United States
(12) Patent Application Publication
(10) Pub. No.: US 2013/0129331 A1
(43) Pub. Date: May 23, 2013

(54) PORTABLE THAWING UNIT

(71) Applicants: Alexandre Henryli de Souza, Verona, WI (US); Jerry Norman Guenther, Verona, WI (US); Milo Charles Wiltbank, Verona, WI (US); Franks Eduardo de Souza, Ourinhos-SP (BR)

(72) Inventors: Alexandre Henryli de Souza, Verona, WI (US); Jerry Norman Guenther, Verona, WI (US); Milo Charles Wiltbank, Verona, WI (US); Franks Eduardo de Souza, Ourinhos-SP (BR)

(21) Appl. No.: 13/298,527

(22) Filed: Nov. 17, 2011

(51) Int. Cl. A61D 19/02; A45F 5/02; F24H 1/20; F24H 1/06; H05B 1/02

(52) U.S. Cl. 392/445; 392/446; 219/494; 224/195; 600/35

(57) ABSTRACT

A portable thawing unit for heating animal fluids and cells (stored in straws) includes a main casing for holding water therein. A lower body secured to the main casing includes a battery pack and plug for recharging the battery pack. An upper body secured to the main casing allows at least one straw to enter the main casing for immersion in the heated water. A heating element and thermistor heat the water in the main casing to a desired temperature. A straw rack unit having at least one straw shaft holds straws and allows them to be lowered and raised. A motor powered by the batter pack runs a propeller that helps mix the water. The thawing unit does not allow straws in the main casing to contact each other, allowing, for example, 95 to 98.6 degrees Fahrenheit water to better contact the straws and heat them more efficiently.

### FIELD OF THE INVENTION

This document concerns an invention relating generally to portable thawing devices, and more specifically to a battery-operated device well suited for heating biochemical products, such as animal semen to be used for artificial insemination.

### BACKGROUND OF THE INVENTION

In farms and laboratories, animals (such as bovines) that have high genetic value (because, for example, they are relatively less prone to disease or have higher milk production) are multiplied through artificial insemination (AI). Semen of high-value male animals is mixed with an extender (such as glycerol) and frozen in semen straws until the semen is to be used to inseminate female animals. Before insemination can occur, the semen is thawed and brought to an appropriate temperature. For bovine insemination, for example, semen is often thawed using a water bath heated to a temperature range of 96 to 98.6 degrees Fahrenheit (35 to 37 degrees Celsius). Because extenders can be toxic to sperm, semen should be used (thus diluting the extender in the cow's uterine tract) within ten to fifteen minutes of being thawed.

Traditional heating devices used to thaw semen straws must be plugged into an external energy source at all times. As the animals to be inseminated are often not located near power outlets, the AI technician generally needs to return to an office with a power outlet to thaw the semen. The AI technician has about ten minutes to use a thawed semen straw, so he or she cannot thaw more than can be used in ten minutes (taking into account the time it takes to travel from the heating device to the animals being inseminated). If three semen straws can be used in 10 minutes, the technician must return to the heating device each time three animals are inseminated. It is common to breed over 100 cows or more each day in dairy herds of the United States. If 100 animals are to be bred in one day, the technician must return to the office over 30 times to thaw semen straws using the traditional heating device.

What is needed is a convenient and easy-to-use portable thawing unit for heating biological fluids and cells, such as semen to be used for artificial insemination of animals.

### SUMMARY OF THE INVENTION

The invention, which is defined by the claims set forth at the end of this document, is directed to a portable thawing unit that at least partially alleviates the aforementioned problems. A basic understanding of some of the features of preferred versions of the invention can be attained from a review of the following brief summary of the invention, with more details being provided elsewhere in this document. To assist in the reader's understanding, the following review makes reference to the accompanying drawings (which are briefly reviewed in the “Brief Description of the Drawings” section following this Summary section of this document).

Referring initially to FIG. 1, an exemplary handheld thawing unit 10 for heating biochemical products (such as animal fluids and cells) includes a main casing 100 between an upper body 200 and a lower body 300. The main casing 100 provides a main casing interior 110 for holding liquid (such as water) therein. The lower body 300, which is removably secured to the main casing 100 from below, includes a lower body enclosure 310 with a rechargeable battery pack 400 housed therein. A heating unit 430 powered by the battery pack 400 heats water in the main casing interior 110 to, for example, 95 to 98.6 degrees Fahrenheit. The upper body 200 is removably secured to the main casing 100 from above to enclose the main casing interior 110. At least one biological fluid straw 570 (containing, for example, frozen bovine semen) can enter the main casing interior 110 through the upper body 200. A user is able to take the portable thawing unit 10 into the field and conveniently heat fluids by immersing the fluid straws 570 into heated water as needed.

To provide for more efficient heating of the water, a propeller 420 is preferably included to help mix the water and enhance temperature uniformity. A motor unit 410 powered by the battery pack 400 spins the propeller 420 via motor shaft 415. Because the straws 570 are heated when they contact the heated water, the heated water should preferably be able to access the straws 570 from all sides. Accordingly, the straw rack unit 500 prohibits fluid straws 570 inserted into the main casing interior 110 from touching each other, enhancing the efficiency of straw heating. One or more straw rack units 500 allow fluid straws 570 to be lowered into and raised from the main casing interior 110. The straw rack unit 500 allows the fluid straws 570 to be transposable between an upper position (see the rightmost two straws in FIG. 3) in which at least a portion of the fluid straw 570 extends out of the thawing unit 10 (allowing the straw to more easily be gripped for removal), and a lower position (see the leftmost two straws in FIG. 3) in which the fluid straw 570 does not extend above the upper body 200.

The portable thawing unit 10 provides a convenient means of heating biological fluids without being tethered to power outlets. The thawing unit 10 is easy to use, allowing multiple straws 570 to be handled and heated efficiently. Because thawed sperm removed from a hot water bath is prone to cold shock, the thawing unit 10 allows semen straws to be thawed near the animals to be inseminated, minimizing the time the straw spends between thawing and insemination. The propeller 420 keeps water in constant motion for better temperature exchange between the water and fluid straws 570, increasing the thaw rate and likely improving sperm membrane integrity. The thawing unit 10 is easy to clean because it can be readily disassembled from the upper and lower bodies 200, 300. As the viability of the sperm is enhanced at least from decreased cold shock and decreased time spent in undiluted extender, the success rate of the insemination process is enhanced, saving time and lowering costs. Additional advantages and features of the invention will be apparent from the remainder of this document in conjunction with the associated drawings.

### BRIEF DESCRIPTION OF THE DRAWINGS

FIG. 1 is an exploded view of an exemplary thawing unit 10, showing an upper body 200 and a lower body 300 at opposing ends of the main casing 100, and a disassembled straw rack unit 500 from the rear.

FIG. 2A is a front perspective view of the straw rack unit 500 of FIG. 1.

FIG. 2B is a front view of the assembled straw rack unit 500 of FIG. 2A.

FIG. 3 is an exemplary thawing unit 10 from the front, with two fluid straws 570 in an upper position at openings I and II, with two fluid straws 570 in a lower position at openings V and VI, and with openings III and IV unoccupied by fluid straws 570.

FIG. 4 is a rear perspective view of the thawing unit 10 of FIG. 3, showing a battery recharge plug 490 and on/off switch 495 at the lower body 310.

FIG. 5A shows the main casing of FIG. 1 having an exemplary main clip 20 for securing the thawing unit 10 to, e.g., clothing. FIG. 5B shows an exemplary utility belt 30 to which the thawing unit 10 can be secured via the main clip 20 of

FIG. 5A. FIGS. 5C and 5D show an exemplary towel dispenser 40.

### DETAILED DESCRIPTION OF PREFERRED VERSIONS OF THE INVENTION

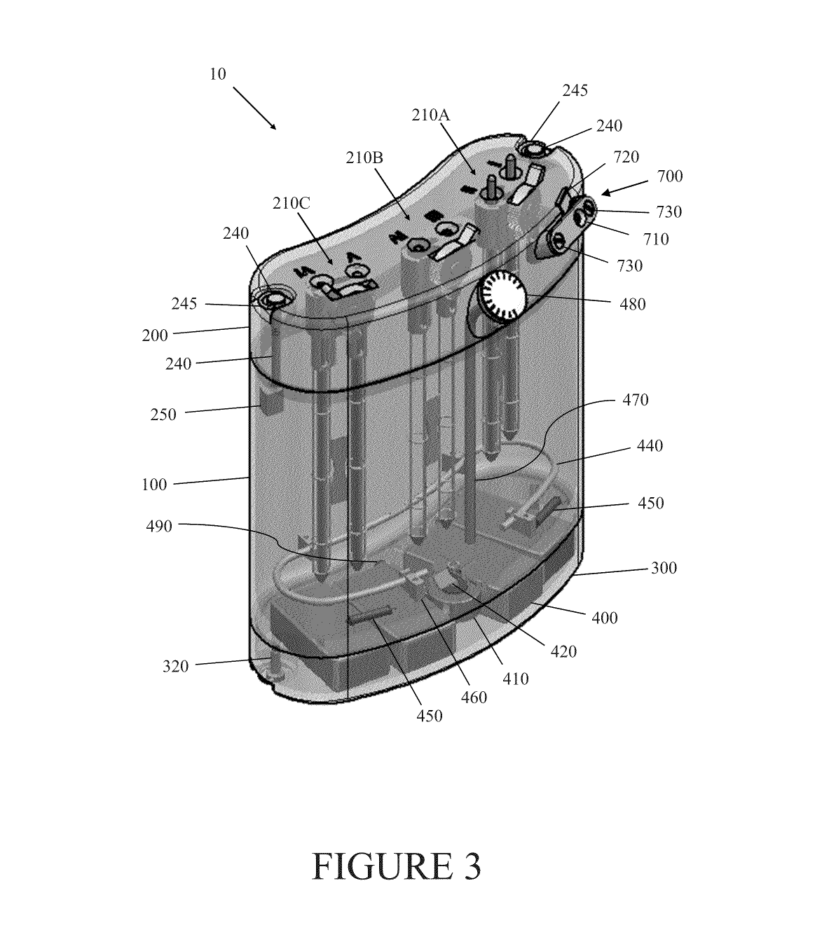

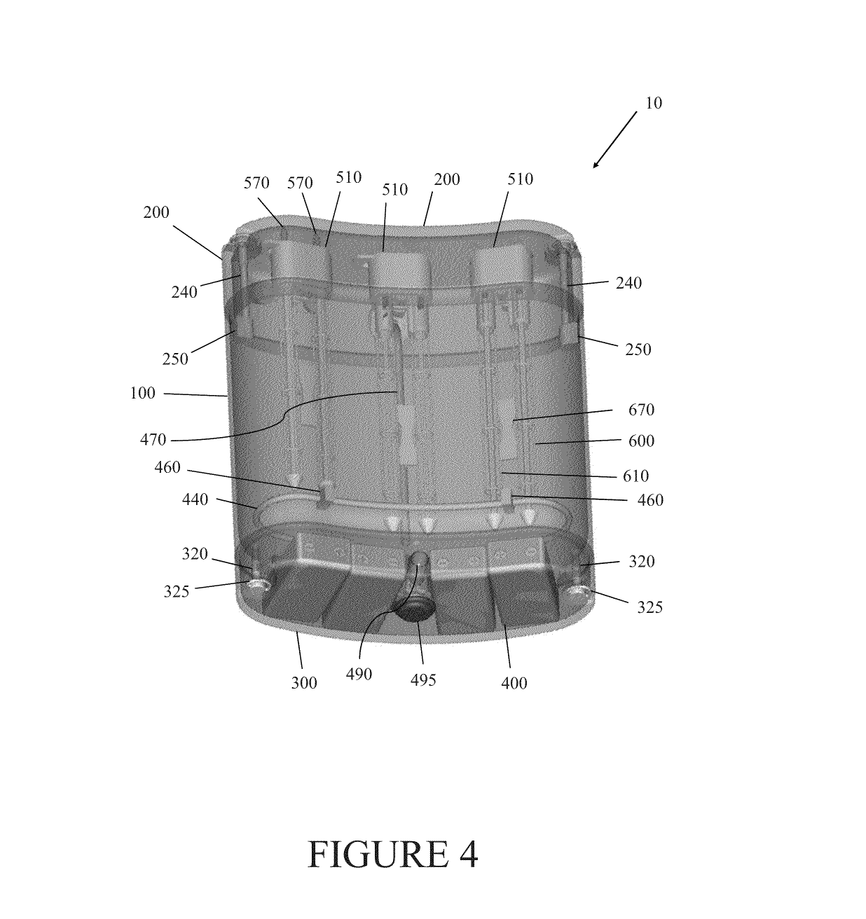

Turning initially to the exemplary thawing unit 10 of FIG. 3, the main casing 100 is removably attachable to the upper body 200 and the lower body 300, allowing the main casing 100 to be disassembled for separate cleaning The upper body 200 includes a pair of upper body pins 240, each upper body pin 200 having an upper body pin ring 245 extending therethrough. Opposing sides of the main casing 100 include a pair of upper body braces 250. To secure the upper body 200 to the main casing 100, the upper body 200 is positioned over the main casing 100 from above, and the upper body pins 240 are pressed down so that they are received by corresponding upper body braces 250. The upper body 200 preferably makes a watertight seal when secured to the main casing 100 so that the water in the main casing 100 does not spill out when the assembled thawing unit 10 is tipped. To disconnect the upper body 200 from the main casing 100, the upper body pins 240 are pulled upwards via the upper body pin rings 245, retracting the upper body pins 240 from the upper body braces 250. The upper body 200 can be removed to add water to (or remove water from) the main casing interior 110. In a similar fashion, to secure the lower body 300 to the main casing 100, the lower body 300 is brought together with the main casing 100 from below and two lower body pins 320 are pressed up so that they enter corresponding lower body braces (not pictured) at the bottom of the main casing 100 (see also FIG. 4).

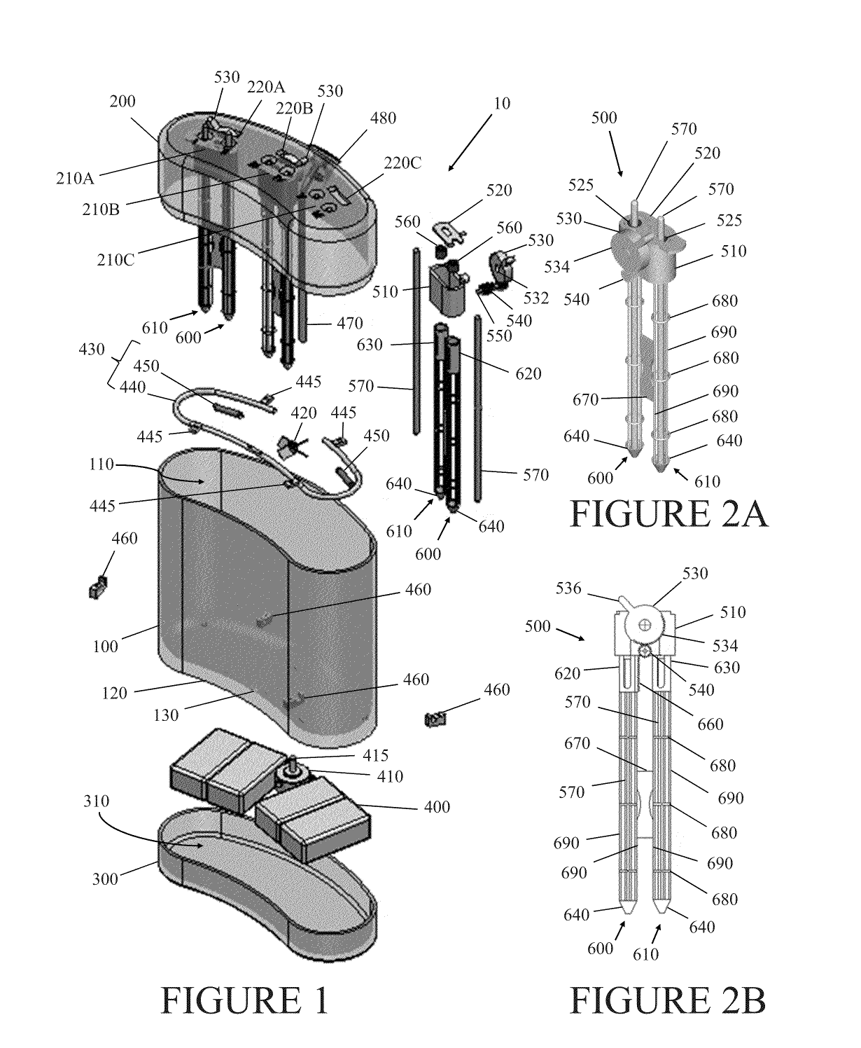

Returning to FIG. 1, the main casing 100 includes a floor 120 with a floor aperture 130 formed therein and a set of floor braces 460 secured thereto. The floor aperture 130 provides the lower body 300 (and the electrical components therein) access to the main casing interior 110. The enclosure of the lower body 300 preferably houses the battery pack 400 having, for example, four 9-volt batteries. Referring to FIG. 4, the lower body enclosure 310 also includes a recharge plug 490 for recharging the battery pack 400, and an on/off switch 495 for turning the thawing unit 10 on and off.

As show in FIG. 1, the heating unit 430 powered by the battery pack 400 includes a heating element 440 (such as a resistance wire) to heat the water in the main casing 100, the heating element 440 including holding points 445 for securing the heating element 440 to main casing floor braces 460. The heating unit 430 also preferably includes a heating regulator 450 (such as a positive temperature coefficient (PTC) thermistor, the resistance of which increases with increasing temperatures) configured to heat the water to desired temperatures. With the resistance wire 440 and PTC thermistor 450 connected in series, the thermistor 450 in effect provides “negative feedback” by behaving as a current limiter for the resistance wire 440. That is, a PTC thermistor 450 suited for a given temperature range might be configured to have the highest resistance (and thus the lowest level of heating by the resistance wire 440) once the temperature range has been reached.

The upper body 200 includes three pairs of straw openings 210A (I and II), 210B (III and IV), 210C (V and VI), and three corresponding lever openings 220A, 220B, 220C. Referring also to FIGS. 2A and 2B, each pair of straw openings corresponds with a straw rack unit 500 when the thawing unit 10 is assembled. Each straw rack unit 500 includes a primary straw shaft 600 and a secondary straw shaft 610, each shaft 600, 610 extending from a shaft head 620, 630 to a shaft stop 640. A cap sealant 520 is secured to a straw rack body 510, with apertures 525 formed in the cap sealant 520 to allow fluid straws 570 to pass therethrough. Fluid straws are commonly configured to hold 0.5 or 0.25 milliliters therein, but the thawing unit 10 can be configured to accommodate straws of any shape or size. When inserted into the thawing unit 10, fluid straws 570 extend through one of the six straw openings (I to VI) at one of the pairs of straw openings 210A, 210B, 210C in the upper body 200, through an aperture 525 in the cap sealant 520, through a straw holder 560 (see FIG. 1), out through a bottom aperture (not pictured) in the straw rack body 510, and into one of the shafts 600, 610. Once inserted in one of the shafts 600, 610, the sides of the fluid straws 570 are supported by shaft bars 690 extending through shaft rings 680.

A lever 530 having a lever flange 536 is used to transpose the position of the shafts 600, 610 by raising and lowering fluid straws 570 using a “rack-and-pinion” configuration. A gear axle 550 (see FIG. 1) is situated in the straw rack body 510, with the gear axle 550 extending through a side aperture (not pictured) in the straw rack body 510, through a lever aperture 532 formed in the lever 530, and through a small gear 540. The lever 530 has lever teeth 534 that engage teeth on the small gear 540, and the teeth on the small gear 540 engage teeth 660 on the head 620 of the primary shaft 600. As the lever flange 536 is moved rightward in FIG. 2B, the lever 530 rotates clockwise, the small gear 540 rotates counterclockwise, and the primary shaft 600 moves upward. Because the primary shaft 600 is secured to the secondary shaft 610 via a shaft joint 670, the secondary shaft 610 moves upward with the primary shaft 600. When the shafts 600, 610 are in an up position, as are the straws 570 at openings I and II of the first pair of openings 210A in FIG. 3, at least a portion of the straws 570 extend out of the upper body 200. When in a down position (as with openings V and VI of the third pair of openings 210C), the fluid straws 570 have descended so that no portion of the straws 570 extends out of the upper body 200.

Because the fluid is sealed in the straw 570, the tips of the straws 570 are cut off to access the fluid therein. Referring to FIG. 3, the thawing unit 10 preferably includes a cutter unit 700 secured to, for example, the upper body 200 using two cutter fasteners 730. The cutter unit 700 includes a cutter port 710 into which the tip of a straw 570 can be inserted. A spring-biased cutter blade 720 is secured to the cutter unit 700, with a portion of the cutter blade 720 extending out of the cutter unit 700 in its default position. When pressed in a downwardly direction, the cutter blade 720 enters the cutter unit 700 and segments the cutter port 710, cutting open the straw 570 inserted through the cutter port 710. When the spring-biased cutter blade 720 is released, the blade 720 retracts from the cutter port 710 and returns to its default position, allowing one fluid straw 570 to be pulled out of the cutter port 710 and another fluid straw 570 to be inserted into the cutter port 710.

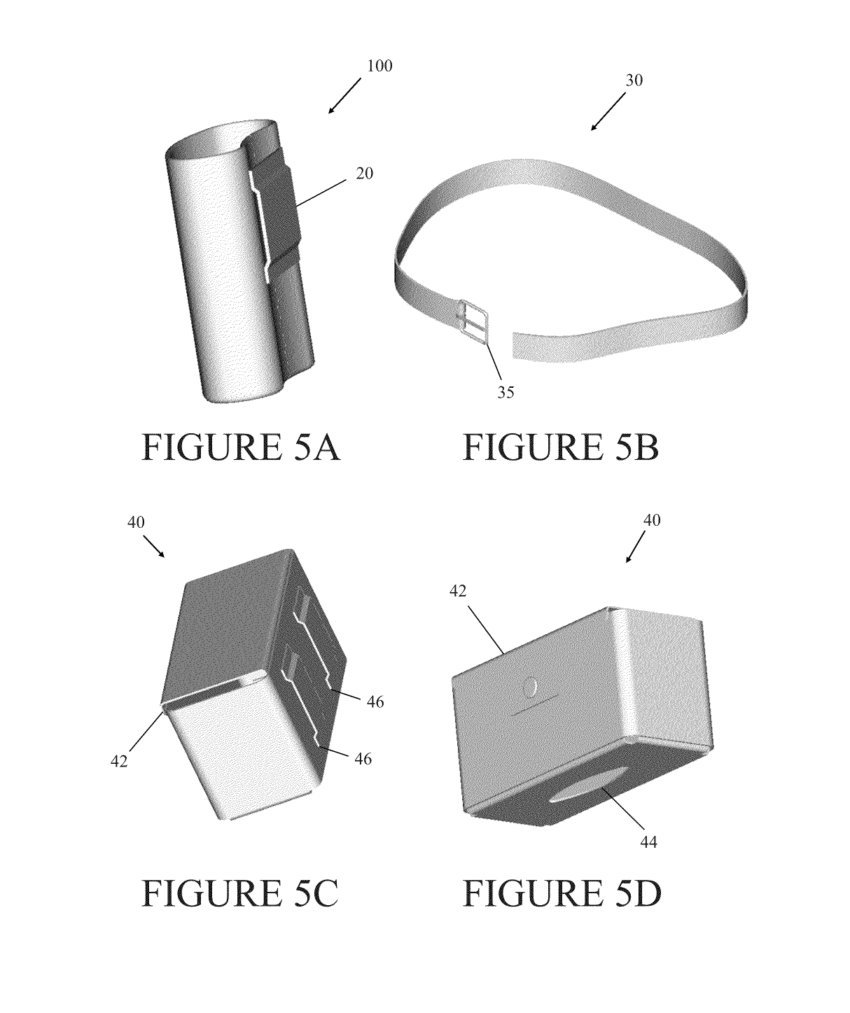

To use the thawing unit 10, the user may begin by securing the lower body 300 to a clean main casing 100 from below. Water is added to the main casing interior 110, and the upper body 200 is secured to the main casing 100 from above. The thawing unit 10 is preferably secured to the user's utility belt 30 (see FIG. 5B) or other clothing using a main clip 20 (see FIG. 5A) extending from the rear of the main casing 100, and the thawing unit 10 can be turned on using the on/off switch 495. The temperature of the water is measured by a thermometer (see FIGS. 3 and 4) extending down into the main casing interior 110. A thermometer readout 480 displays the temperature, and the thawing unit 10 is ready for use when the desired temperature is reached (such as 95 to 99 degrees Fahrenheit).

A portable cool chest or nitrogen tank (not pictured) is preferably also carried by the user (by, for example, also being secured to the utility belt 30). The cool chest might contain up to 50 straws 570 with frozen bovine semen therein, and allows the user to save trips otherwise required to retrieve frozen straws. When ready to inseminate a female cow, the user removes one of the frozen straws 570 from the cool chest and inserts the straw 570 into one of the unoccupied shafts 600, 610 by inserting one end through one of the straw openings (at one of the straw openings 210A, 210B, 210C) in the upper body 200. Once the inserted straw's bottom end abuts the shaft stop 640, the lever flange 536 can be turned to lower the straw 570 farther into the main casing interior 110. Convection in the heated water acts to thaw the frozen straw 570, with the propeller 420 helping replace colder water adjacent to the straws 570 with hotter water closer to the heating element 440. If several frozen straws 570 are inserted into the thawing unit 10 at once, the temperature of the water might initially drop substantially but rise again as the heating unit 430 reheats the water. The user can monitor the thermometer readout 480 as a guide to gauge the status of the frozen straws 570 being heated. Once a straw 570 has been in the hot water for 30 to 60 seconds, it is placed at the end of an AI gun for inseminating the cow. The cutter unit 700 is used to cut the tip of the straw 570 off so the semen therein can be accessed. If more than one straw 570 is being thawed at the same time, the straws can be removed from thawing unit 10 in turn. A towel dispenser 40 (see FIGS. 5C and 5D) can be secured to the utility belt 30 (via, for example, a pair of dispenser clips 46) to carry paper/cloth towels or wipes. The towel dispenser can include a dispenser lid 42 that hingedly opens and closes, and a bottom-opening dispenser port 44 through which towels/wipes can be individually accessed. The relatively less exposed positioning of the dispenser port 44 helps the towels/wipes remain cleaner by allowing them to be less prone to, for example, contact with unclean surfaces and dust. An optional neoprene bag (not pictured) can also be used to hold the thawing unit 10, towels/wipes (and/or the towel dispenser 40), tail chalks for heat detection, and the cool chest holding frozen straws 570. Other pouches and containers can be secured to the utility belt 30 as desired to carry additional desired items, such as replacement parts and a replacement charged battery pack 400.

The thawing unit 10 can be made using any suitable materials, such as, for example, neoprene or plastics. The thawing unit 10 preferably insulates heat therein, but is not too hot to the touch on its exterior. The towel dispenser 40 can be made from, for example, canvas or other materials.

It should also be understood that various terms referring to orientation and position are used throughout this document—for example, “above” (as in “secured to the main casing 100 from above”) and “bottom” (as in “the bottom of the main casing 100”)—are relative terms rather than absolute ones. In other words, it should be understood (for example) that the upper body 200 would be brought together with the main casing 100 from below if the main casing 100 is upside-down. Thus, such terms should be regarded as words of convenience, rather than limiting terms.

Also in the following description, it is to be understood that such terms as “forward,” “rearward,” “left,” “right,” “upwardly,” “downwardly,” and the like are words of convenience and are not to be construed as limiting terms.

Various preferred versions of the invention are shown and described above to illustrate different possible features of the invention and the varying ways in which these features may be combined. Apart from combining the different features of the foregoing versions in varying ways, other modifications are also considered to be within the scope of the invention. Following is an exemplary list of such modifications.

First, although the thawing unit is discussed with respect to straws containing semen, the thawing unit can be used to transfer heat to any biological/chemical (for example, embryos) and/or non-biological/chemical (for example, electrical or mechanical components and devices) solids and non-solids. The items to receive heat can be immersed directly into a hot water bath, or housed in one or more enclosures (such as the straws discussed above or other shell-like structures) so as to limit exposure to water and/or exert control over heat transfer dynamics. For example, a double-enclosure structure can be used (with, for example, an air gap between inner and outer enclosures) to not only keep dry the items being heated, but to limit heat shock from more direct contact with hot water.

Second, the various components of the thawing unit 10 can be rearranged as desired. For example, the lower body enclosure 310 might include only the battery pack 400 and recharge plug 490, with the motor and propeller 420 provided within the main casing interior 110. Alternatively, the motor unit 410 and propeller 420 might remain with the main casing 100 (by, for example, extending down from the floor 120), with the motor unit 410 and propeller 420 situated within the lower body enclosure 310 only when the lower body 300 is secured to the main casing 100.

Third, the main casing 100 need not have a floor 120. When the main casing 100 is secured to the lower body 300, the main casing interior 110 could be contiguous with the lower body enclosure 310. The battery pack 400 would preferably be configured to withstand being immersed in heated water for extended periods of time if this configuration is utilized.

Fourth, the number of straw shafts 600, 610 can be adjusted to be higher or lower than the six shown in the figures. Also, rather than two shafts 600, 610, each straw rack unit 500 can be provided with only one shaft, allowing shafts to be individually raised and lowered, or more than two shafts, allowing several shafts to be raised and lowered together. Moreover, the distance between the shafts 600, 610 can be adjusted so that, for example, all the six shafts in the thawing unit 10 are equidistant from each other and/or from the sidewall of the main casing 100.

Fifth, the heating unit 430 need not have a heating regulator 450, such that the heating unit 430 continues to heat the water in the main casing 100 as long as the thawing unit 10 is switched on. With such a thawing unit 10, the user can monitor the temperature of the water using the thermometer readout 480, and turn the thawing unit 10 on or off as needed to maintain the temperature within a desired temperature range. The heating regulator 450 is preferable if no thermometer is provided with the thawing unit 10, as overheating the liquid could damage biological fluids and cells being heated, and would tend to waste battery charge.

The invention is not intended to be limited to the preferred versions of the invention described above, but rather is intended to be limited only by the claims set out below. Thus, the invention encompasses all different versions that fall literally or equivalently within the scope of these claims.

What is claimed is:

1. A portable thawing unit for heating animal biological products, the thawing unit including:
a. a main casing defining a main casing interior configured to hold liquid therein;
b. an upper body removably secured to the main casing to enclose the main casing interior, the upper body:
i. being configured to permit at least two fluid straws to enter into the main casing interior from above; and
ii. having a straw rack unit configured to prohibit inserted fluid straws from touching each other; and
c. a heating unit configured to heat the main casing interior.

2. The thawing unit of claim 1 wherein:
a. the thawing unit further includes a lower body removably secured to the main casing, the lower body having a lower body enclosure with a battery pack configured to power the heating unit; and
b. the battery pack is sealed from liquid contained in the main casing interior.

3. The thawing unit of claim 2 wherein:
a. the thawing unit further includes a propeller having access to liquid in the main casing interior; and
b. the lower body further includes a motor unit powered by the battery pack, the motor unit being configured to spin the propeller.

4. The thawing unit of claim 1 wherein the thawing unit further includes:
a. a lower body having a lower body enclosure, the lower body being removably secured to the main casing; and
b. a floor positioned between the main casing and the lower body, the floor:
i. separating the lower body enclosure from the main casing interior; and
ii. having a motor unit aperture configured to provide the motor unit access to the main casing interior.

5. The thawing unit of claim 4 wherein the floor is configured to provide a watertight seal between the main casing and the lower body.

6. The thawing unit of claim 1 wherein the heating unit:
a. is positioned in the main casing interior; and
b. includes a heating regulator configured to regulate the heat released into the main casing interior.

7. The thawing unit of claim 6 wherein:
a. the main casing interior includes a liquid;
b. the heating unit is configured to maintain the temperature of the liquid in the main casing between at least substantially 95 degrees Fahrenheit and at least substantially 99 degrees Fahrenheit.

8. The thawing unit of claim 1 wherein the fluid straws are transposable between:
a. an upper position in which at least a portion of the fluid straw extends above the upper body; and
b. a lower position in which at least substantially none of the fluid straw extends above the upper body.

9. The thawing unit of claim 1 wherein the straw rack unit includes at least one straw shaft descending into the main casing interior, each straw shaft having a shaft interior configured to complementarily receive a fluid straw therein.

10. The thawing unit of claim 9 wherein each shaft includes a rack stopper configured to prohibit a straw from descending farther into the main casing interior.

11. The thawing unit of claim 1 wherein the thawing unit further includes a thermometer extending into the main casing interior, the thermometer having a readout portion extending above the upper body, the readout portion indicating a temperature within the main casing interior.

12. The thawing unit of claim 1 wherein the thawing unit further includes a straw cutter secured thereto, the straw cutter being configured to:
a. receive a portion of a fluid straw; and
b. cut a portion of the fluid straw.

13. The thawing unit of claim 1 further including a main clip secured to the main casing, the clip being configured to secure the thawing unit to an article of clothing.

14. The thawing unit of claim 13 in combination with a utility belt configured to engage the main clip to secure the thawing unit to a user's waist.

15. The thawing unit of claim 14 further in combination with a cool chest configured to:
a. hold a set of frozen straws therein; and
b. be securable to the utility belt.

16. The thawing unit of claim 14 further in combination with a towel dispenser configured to:
a. be securable to the utility belt; and
b. dispense towels individually.

17. The thawing unit of claim 16 wherein the towel dispenser includes a dispenser port positioned so as to limit the exposure of towels therein to dust.

18. A portable thawing unit for heating animal biological products, the thawing unit including:
a. a main casing having a main casing interior for receiving liquid therein;
b. an upper body removably securable to the main casing, wherein the upper body is configured to permit a fluid straw to be removably inserted into the liquid in the main casing interior; and
c. a lower body removably securable to the main casing,
i. the lower body having a lower body enclosure housing a battery pack therein,
ii. wherein the battery pack is sealed from the liquid in the main casing interior when the lower body is secured to the main casing; and
d. a heating unit configured to heat the liquid in the main casing interior, the heating unit powered by the battery pack.

19. The thawing unit of claim 18 wherein:
a. the lower body enclosure further houses a motor unit; and
b. the thawing unit further includes a propeller extending from the motor unit, the propeller being configured to propel the liquid in the main casing interior.

20. The thawing unit of claim 18 wherein the thawing unit further includes a straw rack unit having two straw shafts, each straw shaft having a straw shaft long axis, wherein:
a. the straw shaft long axes of the two straw shafts are at least substantially parallel with each other;
b. each straw shaft is configured to complementarily receive a straw therein; and
c. the two straw shafts are configured to maintain a distance between straws inserted therein.

21. The thawing unit of claim 20 wherein the straw rack unit further includes a lever configured to adjust a depth of straws inserted in the straw shafts.

22. The thawing unit of claim 18 further including a floor, the floor:
a. having an aperture configured to complementarily receive a motor shaft of the motor unit; and
b. being configured to provide a watertight seal between the liquid in the main casing interior and the lower body enclosure.

23. The thawing unit of claim 18
a. further including a main clip secured thereto; and
b. in combination with a utility belt configured to be receivable by the main clip.

24. The thawing unit of claim 23 further in combination with a cool chest configured to hold frozen straws therein, the cool chest being securable to the utility belt.

25. The thawing unit of claim 24 further in combination with a towel dispenser having:
a. a dispenser clip configured to make the towel dispenser securable to the utility belt; and
b. a dispenser port configured to provide access to towels stored in the towel dispenser, the dispenser port opening downwardly;

26. A portable thawing unit for heating animal biological products, the thawing unit including:
a. a main casing surrounding a main casing interior, the main casing having a main casing open top;
b. an upper body sized to be complementarily received at the main casing open top to enclose the main casing interior, the upper body having:
i. at least two upper body apertures, each upper body aperture being configured to permit a fluid straw to be retractably inserted into the main casing interior from above; and
ii. a straw rack unit configured to maintain a distance between fluid straws inserted in the main casing interior, the distance being greater than a width of the fluid straws;
c. a lower body configured to be removably secured to the main casing, the lower body having a lower body enclosure with a battery pack and a motor unit;
d. a heating unit configured to heat the main casing interior; and
e. a propeller propelled by the motor unit, the propeller having access to the main casing interior.

27. The thawing unit of claim 26 wherein:
a. the main casing interior includes a liquid, the liquid being agitated by the propeller; and
b. the heating unit includes a heating regulator configured to maintain the temperature of the liquid in the main casing between at least substantially 95 degrees Fahrenheit and at least substantially 99 degrees Fahrenheit.

28. The thawing unit of claim 27 wherein the straw rack unit includes a lever configured to make the fluid straws transposable between:
a. an upper position in which at least a portion of the fluid straw extends above the upper body such that a user may grip the fluid straw by hand; and
b. a lower position in which the fluid straw is at least substantially contained within the thawing unit.

29. The thawing unit of claim 28 in combination with:
a. a utility belt configured to secure the thawing unit to a user's waist; and
b. a cool chest secured to the utility belt, the cool chest configured to hold frozen straws therein.

30. The thawing unit of claim 29 further in combination with a towel dispenser secured to the utility belt, the towel dispenser having a dispenser port configured to provide access to towels from below.
